(19) United States
(12) Patent Application Publication
(10) Pub. No.: US 2003/0029276 A1
(43) Pub. Date: Feb. 13, 2003

(54) Rechargeable electric corkscrew

(76) Inventor: Gerard Falcone, Berkeley Township, NJ (US)

Correspondence Address: Michael I. Kroll, 171 Stillwell Lane, Syosset, NY, 11791, US

(21) Appl. No.: 09/927,057

(22) Filed: Aug. 9, 2001

(51) Int. Cl. B67B 7/00

(52) U.S. Cl. 81/3.2

(57) ABSTRACT

The present invention is a rechargeable electric corkscrew having a reversible rotatable auger mechanically associated with a motor contained within a hand held housing unit. A power button initiates rotation of the auger shaft and the burrowing of the auger into the cork. The penetration of the auger into the cork causes the auger guide to travel along the auger shaft towards the handle thereby compressing the return spring until full penetration is achieved and the top of the auger guide mates with contacts on the feet of the extraction rods to operate a relay switch or other like mechanism to initiate the extension of the extraction rods. The extending extraction rods exert a bias against the auger guide and draw the cork and the auger from the neck of the bottle into a recess within the auger guide.

### BACKGROUND OF THE INVENTION

1. Field of the Invention

The present invention relates generally to corkscrews, and more specifically, to a rechargeable electric corkscrew having a reversible rotatable auger mechanically associated with a motor contained within a hand held housing unit. When a user wishes to remove a cork from a bottle he must simply place the auger guide over the mouth of the bottle, which centers the auger tip on top of the cork, and then press the power button to initiate rotation of the auger shaft and the burrowing of the auger into the cork. The penetration of the auger into the cork causes the auger guide to travel along the auger shaft towards the handle thereby compressing the return spring until full penetration is achieved and the top of the auger guide mates with contacts on the feet of the extraction rods to operate a relay switch or other like mechanism to initiate the extension of the extraction rods. The extending extraction rods exert a bias against the auger guide and draw the cork and the auger from the neck of the bottle into a recess within the auger guide.

2. Description of the Prior Art

There are other motorized corkscrew devices designed for removing corks from bottles. Typical of these is U.S. Pat. No. 1,938,484 issued to G. F. Clarin on Dec. 5, 1933.

Another patent was issued to Leo Bertram et al. on Jan. 20, 1987 as U.S. Pat. No. 4,637,283. Yet another U.S. Pat. No. 4,955,261 was issued to Yung-Tung Chiang on Sep. 11, 1990 and still yet another was issued to Frank W. Spencer Jr. on Jan. 14, 1992 as U.S. Pat. No. 5,079,975.

Another patent was issued to Sandor Bocsi et al. on Mar. 17,1992 as U.S. Pat. No. 5,095,778. Yet another U.S. Pat. No. 5,351,579 was issued to Robert Metz et al. on Oct. 4, 1994. Another was issued to George J. Federighi, Sr. on Dec. 13, 1994 as U.S. Pat. No. 5,372,054. Another was issued on Apr. 2, 1996 to F. Rhett Brockington as U.S. Pat. No. 5,503,047 and still yet another was issued on Mar. 10, 1998 to Robert A. May as U.S. Pat. No. 5,724,869. A patent was issued on May 4, 1999 to Donald W. Court as U.S. Pat. No. 5,899,122 and on Aug. 15, 2000 U.S. Pat. No. 6,101,899 was issued to Dusan Nikolic.

Another patent was issued to Yui Lung Tong on Jul. 20, 1988 as United Kingdom Patent No. GB 2 199 813 A. French Patent No. FR2608143 was issued to Raymond Biard on Jun. 17, 1988. On Jan. 25, 1991 a patent was issued to Rene Jean Poirier as French Patent No. FR2649968 and Shen Bo Chang was issued French Patent No. FR2683216 on May 7, 1993. PCT No. WO 94/01359 was issued to Eric Baumard on Jan. 20, 1994.

### U.S. Pat. No. 1,938,484

### Inventor: George F. Clarin

### Issued: Dec. 5, 1933

A cork pulling machine comprising a sleeve, a corkscrew displaced axially in the sleeve, a movable bottle neck guide below the sleeve to align the cork in the bottle neck with the corkscrew, an electric motor, a gear connection between the motor and the corkscrew, a current controlling switch for the motor, a rod carried by the guide and moveable therewith for closing the switch when the guide is moved upwardly to operate the motor to rotate the corkscrew for engagement with the cork to move the same into the sleeve.

### U.S. Pat. No. 4,637,283

### Inventor: Leo Bertram et al.

### Issued: Jan. 20, 1987

A corkscrew comprises a sleeve coaxial with a corkscrew spiral and formed to cooperate with a bottleneck provided with a cork. An electric motor drives the corkscrew spiral by means of a reduction gear, the corkscrew spiral being capable of being screwed into the cork in one direction of rotation with the cork being drawn from the bottleneck without the direction of rotation being reversed, the reduction gear providing a reduction ratio of 60:1 to 100:1, the electric motor being a self-starting two-pole single-phase synchronous motor with a diametrically magnetized permanent-magnet rotor. A reversible unidirectional latch is situated at the driven side of the corkscrew spiral for defining the direction of rotation of the motor, such unidirectional latch cooperating with a part of the reduction gear driven by the motor with an integral reduction ratio. Provision is made to reverse the blocking direction of the unidirectional latch to select one of the two directions of rotation of the motor.

### U.S. Pat. No. 4,955,261

### Inventor: Yung-Tung Chiang

### Issued: Sep. 11, 1990

This disclosure relates to an automatic corkscrew and in particular to one which utilizes a motor in association with a ferrule and a drawing tube to rotate a worm into a cork of a bottle and draw it out automatically. Then, the corkscrew may also withdraw the cork automatically by switching a conversion button.

### U.S. Pat. No. 5,079,975

### Inventor: Frank W. Spencer Jr.

### Issued: Jan. 14, 1992

An automatic corkscrew is capable of both extracting and reinserting a cork from and into a bottle. The corkscrew includes an extraction tube which engages the bottle and forms a cork receiving area. The auger extends through the extraction tube. When rotated in a clockwise direction, the corkscrew first penetrates and then extracts the cork from the bottle. When rotated in the opposite direction, the corkscrew reinserts the cork into the bottle. A gripping means if formed on the extraction tube for gripping the bottle during reinsertion of the cork into the bottle.

### U.S. Pat. No. 5,095,778

### Inventor: Sandor Bocsi et al.

### Issued: Mar. 17, 1992

An electric corkscrew device is provided and consists of a reversible electric motor having a stationary collar and a rotatable shaft. A first sleeve is coupled to the stationary collar of the reversible electric motor, a second sleeve is slideable within the first sleeve, in which the second sleeve is formed to cooperate with a bottle neck provided with a cork. A spring is within the first sleeve to urge the second sleeve towards the bottle neck. A corkscrew spiral is driven by the rotatable shaft of the reversible electric motor and extends through the first sleeve and the second sleeve so that when the corkscrew spiral turns in one direction it can engage the cork and pull it out of the bottle neck. A mechanism is for removing the cork from the corkscrew spiral when the rotatable shaft is reversed by the reversible electric motor and the corkscrew spiral turns in an opposite direction.

### U.S. Pat. No. 5,351,759

### Inventor: Robert Metz et al.

### Issued: Oct. 4, 1994

A rechargeable electric corkscrew for removing a cork from a bottle comprises a reversible drive having a switch for switching the drive between rotation in a first sense and an opposite sense. A body houses the drive and a rechargeable power source and has a rotatably mounted auger extending in a longitudinal direction. A sleeve has a first end adapted for slidably mounting onto the body. The sleeve has a second end surrounding the auger comprising cantilevered members each having an abutment surface adapted to abut a mouth of the bottle. The cantilevered members are adapted to flex for positioning the abutment surfaces relative to each other about the mouth. The cantilevered members has a base end having a radial extent for stably supporting the corkscrew in an upright condition. The corkscrew is also provided with a cutter for cutting a foil wrapper which covers the mouth of the bottle.

### U.S. Pat. No. 5,372,054

### Inventor: George J. Federighi, Sr.

### Issued: Dec. 13, 1994

An apparatus for opening a wine bottle includes a cork seal remover assembly, comprising a housing having a cavity therein, the cavity including opposed side walls that taper downwardly to a bottom opening and converge rearwardly toward a rear wall. A blade assembly is received within the cavity, the blade assembly including a pair of spring arms disposed to impinge resiliently on the side walls of the cavity. The spring arms include arcuate blades in confronting relationship to define a gap therebetween. A bottle neck is inserted between the blades and urged rearwardly, causing the spring arms to converge and the blades to impinge on the seal, severing the end of the seal. The cork remover portion of the invention includes a corkscrew blade disposed coaxially within a tubular housing. The corkscrew blade is operated by a reversible motor, and a sensor within the inner end of the tubular housing is connected to reverse the rotation of the motor and blade. A tubular shuttle is slidably disposed within the housing to accept the upper neck portion of a wine bottle. The shuttle includes an internal stop to limit the insertion depth of the bottle neck, and the tubular housing includes an external stop that limits the translation of the shuttle into the housing. The bottle neck is inserted into the shuttle opening and urged toward the tip of the rotating corkscrew. The corkscrew bores into the cork while also pulling the bottle and shuttle further into the tubular housing. The shuttle encounters the external stop, and the auger effect of the corkscrew pulls the cork from the bottle neck. The cork is withdrawn until the cork strikes the sensor, reversing the motor, the counterclockwise rotation of the corkscrew pushing the cork, bottle, and shuttle distally out of the tubular housing.

### U.S. Pat. No. 5,503,047

### Inventor: E. Rhett Brockington

### Issued: Apr. 2, 1996

A mechanized corkscrew powered by a cordless electric screwdriver, that mimics a winged manual corkscrew, wherein the mechanized corkscrew has a bell shaped flange on a sliding element that retracts up a twin threaded shaft as the corkscrew is twisted into the cork, and then, once the corkscrew is embedded in the cork, the sliding element traverses back down the twin threaded shaft, the resulting action causing the corkscrew to pull the cork out of the bottle.

### U.S. Pat. No. 5,724,869

### Inventor: Robert A. May

### Issued: Mar. 10, 1998

An apparatus for removing a cork from a bottle is disclosed. The apparatus includes a housing, a motor disposed within the housing, and a corkscrew mechanically associated with the motor. An outer sleeve is associated with the housing. A shuttle is displaceably positioned within a channel defined in the outer sleeve. A slide, having a slot therein, is associated with the shuttle. The slot is configured to intercooperate with a rail positioned on the sidewall of the channel. The slide interacts with the rail to render the shuttle nonrotatable about its axis as the shuttle is displaced over a first length of the channel. In a second length of the channel, the shuttle is free to rotate about its axis. The corkscrew extends through a recess defined in the shuttle. A portion of a bottle containing a cork is received within the outer sleeve to engage the shuttle whereby the corkscrew may be inserted into the cork. An operation of the motor causes the corkscrew to be imbedded into the cork. Due to the interaction of the corkscrew and the shuttle, the cork is removed from the bottle.

### U.S. Pat. No. 5,899,122

### Inventor: Donald W. Court

### Issued: May 4, 1999

A new electrically powered corkscrew for aiding in the removal of corks from bottles, such as wine bottles. The inventive device includes a bottle holding unit which supports a bottle thereon and a corkscrew spiral mounted on the holding unit for both rotary motion and longitudinal movement. A first electric motor is coupled to the spiral for rotating the spiral, and a second electric motor is coupled to the spiral for longitudinally moving the spiral. Operation of the motors is controlled by a control unit for operating the spiral to at least partially removing the cork from the bottle.

### U.S. Pat. No. 6,101,899

### Inventor: Dusan Nikolic

### Issued: Aug. 15, 2000

An electrically powered corkscrew has an inclined handle of high ergonomic character to enable convenient and effective use when standing or seated, while ensuring a corkscrew of compact arrangement. The corkscrew has a de-briding cutter concealed in the butt of the handle for removing the usual foil seal from the cork. The cork extracting mechanism includes a dual purpose cork-stabilizing arrangement, including a pair of compression springs and guide posts to assist in countering rotation of the cork, and in assisting reverse operation of the corkscrew auger when discarding the cork.

### U.K. Patent Number GB 2199813A

### Inventor: Yui Lung Tong

### Issued: Jul. 20, 1988

An electrically operated corkscrew comprises a body containing an electric motor drive and a screw for removing corks, the drive being arranged in one sense of rotation to advance the screw to a point where it contacts the cork, and being arranged when rotated in the opposite sense thereafter, to cause retraction of the screw relative the body for withdrawing the cork from the bottle followed by rotation of the screw such that the cork becomes unscrewed from the screw,

### French Patent Number FR2608143

### Inventor: Raymond Biard

### Issued: Jun. 17, 1988

The invention relates to a corkscrew with an electric motor, of the type comprising a stop piece for bearing on the neck of a bottle and a gimlet capable of being driven in rotation in a predetermined direction in order, in a first stage, to penetrate into the cork while moving axially with respect to a stop piece, and, in a second stage, to cause the ascent of the cork while being axially immobilised. The said gimlet is mounted on a body capable of sliding with respect to the stop piece and equipped with the said electric motor in order to drive the gimlet in rotation.

### French Patent Number FR2649968

### Inventor: Rene Jean Poirier

### Issued: Jan. 25, 1991

Corkscrew with electric motor drive which comprises the actuation, in the following order, of means for driving the gimlet (borer) into the stopper, for vertical pulling of the stopper without twisting, and for screwing the stopper from the gimlet, which means are composed of a movable cylinder equipped at its base with an assembly which is itself movable with a system of crosspiece and threaded rod extended by a smooth rod and a gimlet and equipped at its base and at its upper part with fixed stops and permitting the blocking of the crosspiece according to the movement.

### French Patent Number FR2683216

### Inventor: Shen Bo Chang

### Issued: May 7, 1993

The present invention relates to an electric corkscrew which is made up of a minimotor powered by means of batteries. A switch actuates the rotation of the said motor in the pushing-in or pulling-out direction, which drives a speed reduction gear with four planetary gears and the corkscrew proper which is fixed on a plate and which penetrates into the cork and pulls it out by virtue of a movable inner tube having an elongate stop at the lower part locking in a rectangular hole in the body, which immobilizes and limits the movement of the cork during extraction.

### PCT Patent Number WO94/01359

### Inventor: Frank W. Spencer Jr.

### Issued: Jan. 20, 1994

An apparatus driven by a battery-powered electric motor. The motor may be actuated simply by inserting a bottle neck into an abutment portion. The motor drives a corkscrew member via a reduction gear so that it penetrates the seal and cork, and lowers the assembly along two fixed guides. A portion engages a sleeve which a rotational force pivots through ten degrees to enable a circular blade secured to the sleeve to cut through the seal. After the cork has been fully drawn up, the motor switches off, and when the bottle neck is withdrawn, the direction of the rotation is reversed until the cork and seal are ejected, whereafter the motor cuts out. At no time during the whole operation does the user need to handle the apparatus or the bottle. While these motorized corkscrew devices may be suitable for the purposes for which they were designed, they would not be as suitable for the purposes of the present invention, as hereinafter described.

### SUMMARY OF THE PRESENT INVENTION

A primary object of the present invention is to provide a cordless reversible electric corkscrew that will allow a user to remove a cork from a bottle with minimum effort and maximum control.

An additional object of the present invention is to provide a cordless reversible electric corkscrew that is rechargeable.

Another object of the present invention is to provide a cordless reversible electric corkscrew that responds to an activated power button using a two step process to remove the cork wherein the first action is the rotary movement of the auger to penetrate the cork and the second action is the longitudinal extension of the extraction rods to withdraw the cork and the auger from within the neck of the bottle and into a recess within the auger guide.

A yet further object of the present invention is to provide a cordless reversible electric corkscrew having an auger guide that travels along the auger shaft and is maintained distally relative the motor housing by an auger guide return spring.

Still another object of the present invention is to provide a cordless reversible electric corkscrew wherein the rotational penetration of the auger into the cork causes the auger guide to travel along the auger shaft thereby compressing the auger guide return spring until the auger guide makes contact with the extraction rods which activate a switch that stops the axial rotation of the auger shaft and initiates the longitudinal extension of the extraction rods.

Yet still another object of the present invention is to provide a cordless reversible electric corkscrew wherein the extension of the extraction rods exert a bias against the bottle via the auger guide during its distal longitudinal travel thereby retracting the auger and the impaled cork from the bottle and into a recess in the auger guide.

One other object of the present invention is to provide a cordless reversible electric corkscrew wherein the user could manually retract the auger guide to expose the impaled cork and hold it in his hand while activating the power button in the reverse mode to easily remove the cork from the auger.

One more object of the present invention is to provide a cordless reversible electric corkscrew that is simple and easy to use.

A further object of the present invention is to provide a cordless reversible electric corkscrew that is economical in cost to manufacture.

Further objects of the present invention will appear as the description proceeds.

To the accomplishments of the above and related objects, this invention may be embodied in the form illustrated in the accompanying drawings, attention being called to the fact, however, that the drawings are illustrative only, and that changes may be made in the specific construction illustrated and described in the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of the present invention in use.

FIG. 2 is a side view of the present invention.

FIG. 3 is a perspective view of the present invention.

FIG. 4 is a sectional side view of the present invention in use.

FIG. 5 is a sectional side view of the present invention in use.

FIG. 6 is a sectional side view of the present invention in use.

FIG. 7 is a perspective view of the present invention with frictional cover in place.

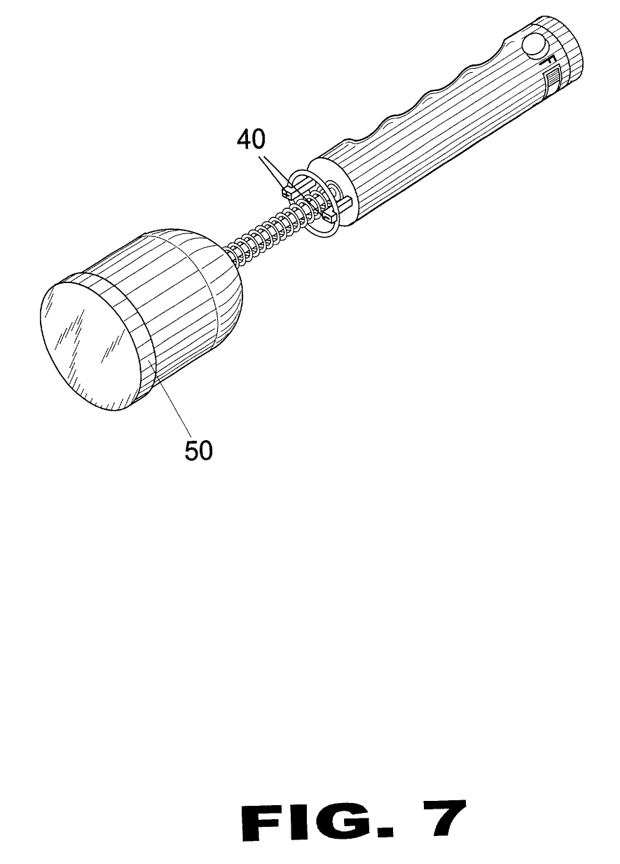

Turning now descriptively to the drawings, in which similar reference characters denote similar elements throughout the several views, the Figures illustrate the rechargeable electric corkscrew of the present invention. With regard to the reference numerals used, the following numbering is used throughout the various drawing figures.

10 rechargeable electric corkscrew of the present invention

12 motor

13 battery operated cork-removing element

14 motor housing

15 auger assembly

16 auger

17 auger tip

18 auger shaft

20 auger guide

21 flanged bottle stop portion of auger guide

22 auger guide recess

23 top portion of auger guide

24 auger guide return spring

25 extraction assembly

26 extraction rods

27 feet of extraction rods

28 extraction rod stabilizing ring

30 rechargeable battery

32 directional switch

34 power button

36 foil cutting element

38 relay switch

40 relay contacts

42 bottle

44 cork

46 user

48 handle portion of electric corkscrew

50 frictional cover

51 recharging element

52 battery charger

53 battery contacts

54 battery charger indicator lights

56 charger housing

58 charger recess

60 power supply cord

### DETAILED DESCRIPTION OF THE PREFERRED EMBODIMENTS

The following discussion describes in detail one embodiment of the invention and several variations of that embodiment. This discussion should not be construed, however, as limiting the invention to those particular embodiments, practitioners skilled in the art will recognize numerous other embodiments as well. For definition of the complete scope of the invention, the reader is directed to appended claims.

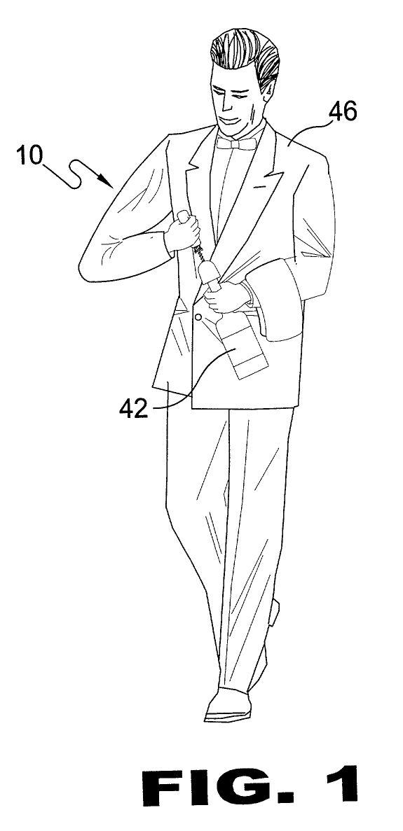

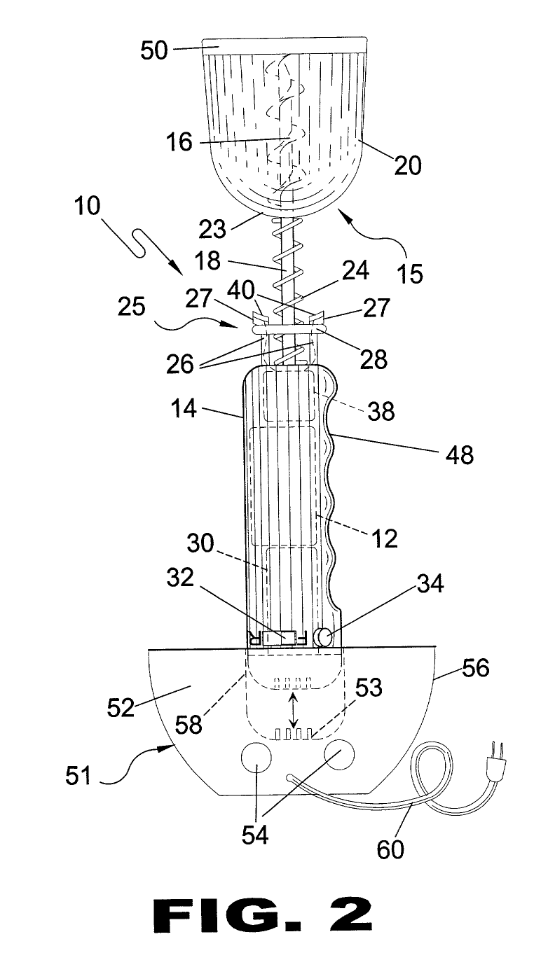

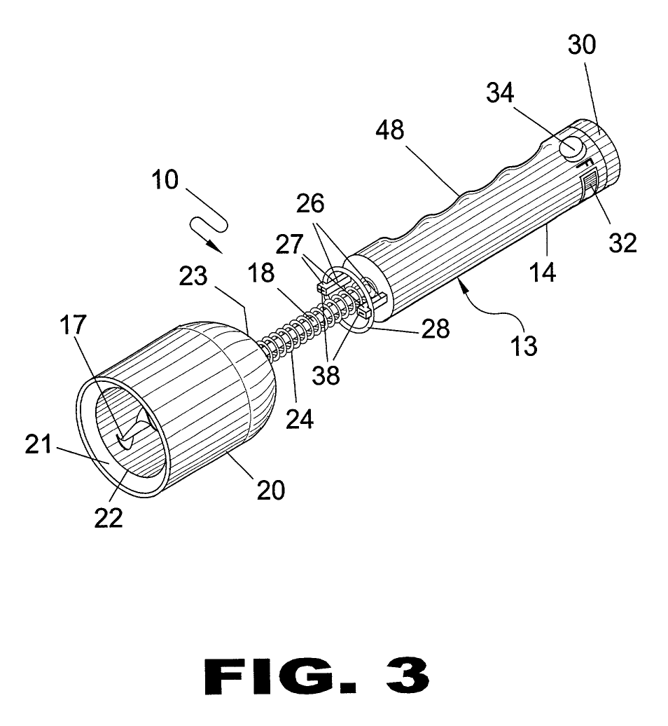

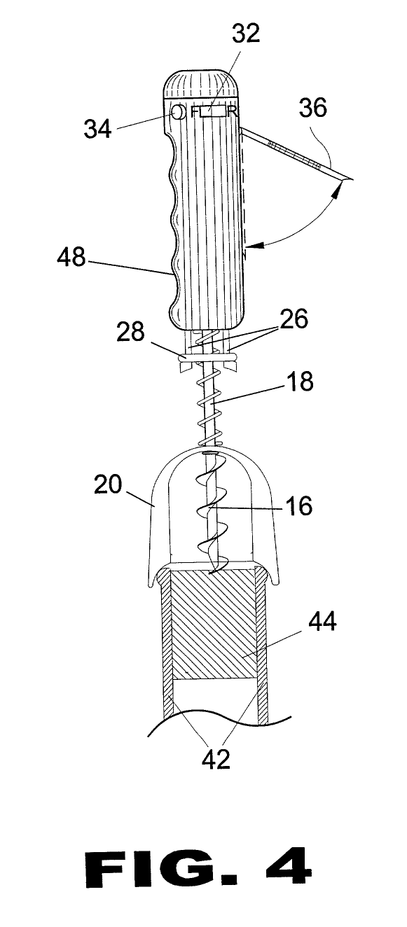

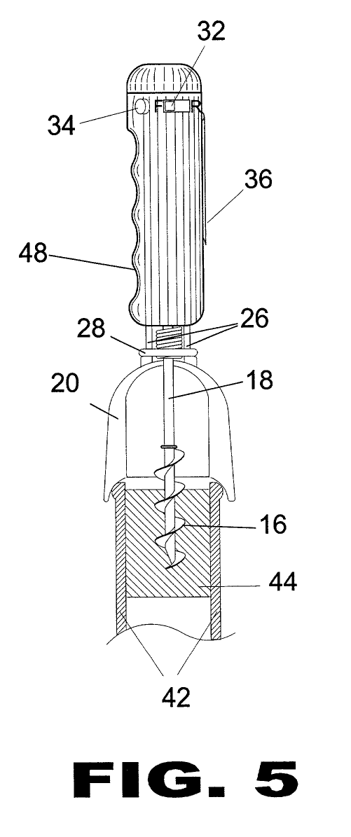

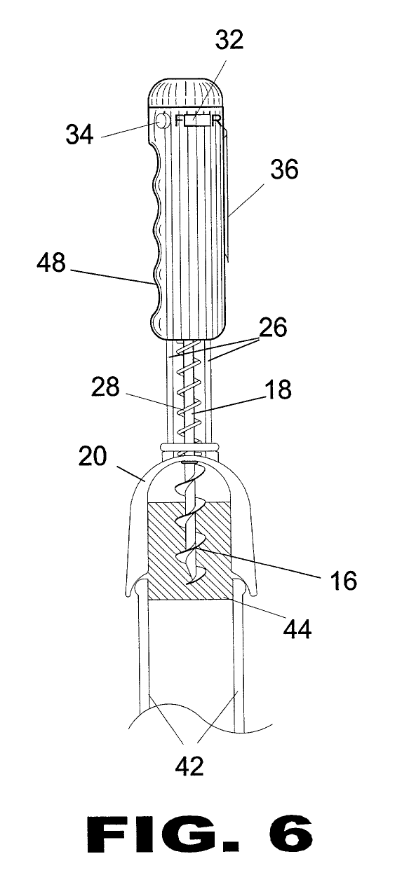

FIG. 1 is a perspective view demonstrating the present invention 10 in use. The operator is using the rechargeable electric corkscrew 10 to remove a cork member 44 from a wine bottle 42 simply by placing the flanged bottle stop portion of the auger guide 21 against the mouth of the bottle 42 to align the auger tip 17 with the center of the cork member 44 and then pressing the power button 34. The present invention 10 will provide the user 46 with a device that will help remove a cork member 44 from a bottle 42 using less energy while providing greater control and thereby eliminating the risk of spillage caused when jerking the cork member 44 out of the bottle 42. Referring now to FIG. 2 is a side view of the rechargeable electric corkscrew 10 comprising a battery operated cork removing element 13 and a recharging element 51. The cork removing element 13 has an integral auger assembly 15 for engaging a cork member 44 and an extraction assembly 25 for removing said cork member 25 and further includes a frictional cover 52 placed over the auger aperture to keep it clean and prevent injury from the auger 16 when stored in the recharging element 51. FIG. 3 is a perspective view of the present invention. A user presses the power button 34 to start the motor 12 to initiate rotation of the auger shaft 18 and the burrowing of the auger 16 into the cork member 44. FIGS. 4, 5 and 6 demonstrate how the penetration of the auger 16 into the cork member 44 causes the auger guide 20 to travel along the auger shaft 18 towards the handle portion 48 thereby compressing the auger guide return spring 24 until full penetration of the auger 16 into the cork member 44 is achieved and the top portion of the auger guide 23 mates with relay contacts 40 on the feet of the extraction rods 27 to operate a relay switch 38 or other like mechanism to disengage the motor 12 from turning the auger shaft 18 and engage with the extraction rods 26 to initiate the extension of the extraction rods 26. The extending extraction rods 26 exert a bias against the top portion of the auger guide 23 and draw the cork member 44 and the auger 16 from the neck of the bottle into a central recess 22 within the auger guide 20. The user slides the auger guide 20 along the auger shaft 18 to reveal the cork member 44 which is grasped in one hand while the hand holding the rechargeable electric corkscrew 10 reverses the axial rotation of the auger shaft 18 by adjusting the directional switch 32 accordingly and then pressing the power button 34 thereby removing the auger 16 from the cork member 44. A pivotally mounted recessed foil-cutting element 36 is incorporated into the handle portion 48.

What is claimed is new and desired to be protected by Letters Patent is set forth in the appended claims:

1. A rechargeable electric corkscrew, comprising:
a) a battery operated cork-removing element; and
b) a recharging element.

2. A rechargeable electric corkscrew as recited in claim 1, wherein said battery operated cork-removing element further comprises:
a) an auger assembly to provide axial penetration to securely engage a cork member that is inside of a bottle;
b) an extraction assembly to apply opposing forces to said bottle and to said cork member therein to provide for the extrication of said cork member therefrom; and
c) an ergonomically shaped handle portion which serves as a housing assembly and includes a motor, said rechargeable battery and other related components for driving said auger assembly and said extraction assembly.

3. A rechargeable electric corkscrew as recited in claim 2, wherein said auger assembly further comprises:
a) an auger rotatably driven by said motor;
b) an auger shaft communicating between said motor and said auger;
c) a substantially cylindrical auger guide that travels along said auger shaft; and
d) a spring element to bias said auger guide along the auger shaft away from the handle portion and towards the distal auger end;

4. A rechargeable electric corkscrew as recited in claim 2, wherein said extraction assembly provides a means for urging said auger guide away from said handle portion once said auger is fully engaged within the cork thereby extracting the cork and said auger from inside the neck of the bottle.

5. A rechargeable electric corkscrew as recited in claim 4, wherein said urging means includes at least two extraction rods that are substantially maintained within the housing of said handle portion until said cork member is fully impaled at which point said motor will engage for the distal extension of said extraction rods.

6. A rechargeable electric corkscrew as recited in claim 5, wherein each said extraction rod has a foot portion on its distal end for making contact with and pushing said auger guide away from said handle portion.

7. A rechargeable electric corkscrew as recited in claim 4, wherein said urging means further include a stabilizing ring to prevent said extraction rods from separating due to the pressure exerted thereon during their distal extension.

8. A rechargeable electric corkscrew as recited in claim 2, wherein said motor is reversible and has a means for mechanically engaging and disengaging between providing the axial rotation of said auger shaft and the distal extension of said extraction rods as needed.

9. A rechargeable electric corkscrew as recited in claim 8, wherein said means for mechanical engagement and disengagement includes a relay switch.

10. A rechargeable electric corkscrew as recited in claim 9, wherein said relay switch has contacts located on said foot portions of said extraction rods whereby pressure applied against said contacts by said auger guide once the cork member is fully impaled will activate said relay switch thereby initiating disengagement of the auger shaft with said motor and engage said extraction rods therewith.

11. A rechargeable electric corkscrew as recited in claim 2, wherein said handle portion has external operator controls.

12. A rechargeable electric corkscrew as recited in claim 11, wherein said operator controls include a power on/off switch and an auger shaft rotational directional switch.

13. A rechargeable electric corkscrew as recited in claim 3, wherein said auger guide includes a top portion, a central recess for receiving a cork member

14. A rechargeable electric corkscrew as recited in claim 1, wherein said auger tip of said battery operated cork removing element is placed centrally against said cork member and said bottle stop is placed against the mouth of said bottle, the auger shaft begins to rotate and screw into said cork member when the operator presses said power on/off button, the auger guide travels up the auger shaft and compresses the spring element as the axial rotation of said auger shaft fully penetrates said cork member until the top portion of the auger guide mates with said relay contacts that activate said relay to disengage said auger shaft from said motor and to then engage said extraction rods therewith, the extension of the extraction rods exert a bias to the auger guide and to the bottle mouth thereby causing said handle portion and said auger assembly with impaled cork member to move away from the auger guide thus effectively removing said cork member from said bottle.

15. A rechargeable electric corkscrew as recited in claim 1, wherein said recharging element comprises:
a) a housing;
b) a recess in said housing to receive the distal handle portion of the rechargeable electric corkscrew;
c) battery contacts within said recess of said housing to mate with said battery in said handle portion of the rechargeable electric corkscrew;
d) a power supply cord; and
e) status indicator lights.
